(19) United States
(12) Patent Application Publication
(10) Pub. No.: US 2026/0017305 A1
(43) Pub. Date: Jan. 15, 2026

(54) SYSTEMS AND METHODS FOR CONTEXT-PRESERVING PINNING AND AI-DRIVEN RETRIEVAL IN CONVERSATIONAL INTERFACES

(71) Applicant: CELLIGENCE INTERNATIONAL LLC, Guaynabo, PR (US)

(72) Inventors: Pavan AGARWAL, DORADO, PR (US); Gabriel Albors SANCHEZ, SAN JUAN, PR (US); Jonathan Ortiz RIVERA, SAN JUAN, PR (US)

(73) Assignee: CELLIGENCE INTERNATIONAL LLC, Guaynabo, PR (US)

(21) Appl. No.: 19/330,586

(22) Filed: Sep. 16, 2025

Related U.S. Application Data
(63) Continuation-in-part of application No. 19/182,453, filed on Apr. 17, 2025.
Application No. 19/182,453 is a continuation-in-part of application No. 18/135,703, filed on Apr. 17, 2023, now Pat. No. 12,393,433.
(60) Provisional application No. 63/332,205, filed on Apr. 18, 2022.

(51) Int. Cl. G06F 16/335

(52) U.S. Cl. CPC G06F 16/337

(57) ABSTRACT

A system and method provide context-preserving pinning and AI-assisted retrieval in a conversational interface. In response to a pin command on a message bubble, the system stores a pinned record including the bubble and a context window of surrounding messages with interaction metadata. A persistent sidebar surfaces latest pinned entry(ies) for low-latency recall. An AI engine updates a user profile from pinned records and provides personalized recommendations and proactive pin suggestions. The approach improves organization, efficiency, and comprehension while enabling privacy-preserving analytics and multi-device synchronization.

### RELATED APPLICATIONS

This application a continuation-in-part of U.S. patent application Ser. No. 19/182,453, filed on Apr. 17, 2025, which is a continuation-in-part of U.S. patent application Ser. No. 18/135,703, filed on Apr. 17, 2023, which claims the benefit of U.S. Provisional Application No. 63/332,205 filed on Apr. 18, 2022, the contents of which are incorporated herein by reference in its entirety.

### FIELD OF INVENTION

The present disclosure relates to user interfaces and data processing systems, and more particularly to pinning, context preservation, and AI-assisted retrieval within conversational user interfaces.

### BACKGROUND

Conventional chat systems allow a user to scroll, search, or star messages; however, these approaches (i) lose conversational context around a saved message, (ii) fail to model user intent from what is saved, and (iii) do not adapt downstream UI or responses. Consequently, users spend time rescanning long threads, and the system misses signals that could personalize assistance.

### SUMMARY

In one aspect, systems and methods are provided for context-preserving pinning and AI-assisted retrieval in a conversational user interface (“PinChat”). A chat interface renders message bubbles and receives a pin command for a selected bubble. In response, the system generates a context window comprising surrounding messages, persists a pinned record that links the bubble to its context and interaction metadata, and surfaces the latest and/or highest-importance pins in a persistent sidebar with low-latency recall that re-displays the bubble together with at least a portion of the stored context.

In some embodiments, the system computes an importance score for each pinned record using features such as time-to-pin, reopen count, dwell duration, and sub-thread activity. A recommendation generator leverages pinned records, context windows, and a user profile to produce personalized outputs, including related messages, suggested actions (e.g., create task, schedule follow-up, export summary), and proactive pin suggestions for similar content. Recommendations and suggestions may be conditioned by tenant-scoped privacy and consent controls.

In another aspect, a non-transitory computer-readable medium stores instructions that, when executed by one or more processors, cause performance of operations including: rendering the chat interface; receiving the pin command; generating and storing the context window with interaction metadata; computing the importance score; updating the user profile from pinned records; and rendering the sidebar and recall overlay for contextual re-presentation of the pinned content.

In certain embodiments, synchronization logic maintains consistency of pinned records across multiple client devices. A local pin cache enables pinning during periods of reduced connectivity and later reconciliation with a server-side pinned-message data store, optionally using causal ordering and/or CRDTs to resolve concurrent edits. In an alternate embodiment, a client access control guard applies on-device redaction or hashing prior to synchronization, and a governance and retention rules engine enforces expiration, legal hold, or regulatory policies over pinned records and derived features.

The disclosed techniques provide technical improvements over conventional “star” or bookmark functionality by deterministically preserving conversational context, capturing interaction signals for importance-aware ranking, and adapting retrieval and assistance behavior based on learned user preferences—thereby reducing navigation steps, improving comprehension, and enabling privacy-preserving, multi-device access to the information that matters most within chat-based workflows.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a block diagram illustrating an exemplary an exemplary system architecture for PinChat, according to an implementation of the disclosure.

FIGS. 2A-2B are diagrams illustrating example user interface elements and workflows for pinning a message bubble within a chat interface, according to an implementation of the disclosure. Image 1

FIG. 3 is a diagram illustrating an exemplary sidebar display of current errands and the latest pinned message within the chat interface, according to an implementation of the disclosure. Image 2

FIG. 4 is a diagram illustrating a chat message bubble marked with a pin indicator, according to an implementation of the disclosure. Image 3

FIG. 5 is a flow diagram illustrating a process for pinning, scoring, and recalling a message within PinChat, according to an implementation of the disclosure.

FIG. 6 is a diagram illustrating exemplary data schemas for pinned messages, context windows, according to an implementation of the disclosure.

FIG. 7 is a block diagram illustrating the recommendation workflow based on pinned messages, context, and user profiles, according to an implementation of the disclosure.

FIG. 8 is a diagram illustrating multi-device synchronization and reconciliation of pinned messages, according to an implementation of the disclosure.

FIG. 9 is a diagram illustrating privacy, governance, and access-control flows in an alternate embodiment of PinChat, according to an implementation of the disclosure.

FIG. 10 illustrates an example computing system that may be used in implementing various features of embodiments of the disclosed technology.

Described herein are systems and methods for pin-aware conversational assistance within a chat interface. During a session, the system allows a user to pin one or more chat messages and associates each pin event with contextual metadata (e.g., surrounding conversation, timestamps, engagement signals). A pin service stores pinned messages in a dedicated data store and maintains linkages to context windows and sub-threads. An AI engine analyzes pinned content to perform topic analysis, importance scoring, and user profiling, and may generate proactive recommendations such as related messages, suggested actions, or recall prompts. Personalization components adapt scoring thresholds and recommendation behavior based on historical accept/decline outcomes, while synchronization modules ensure consistent pin state across multiple client devices. Privacy and governance controls limit retention of sensitive content, ensure only derived features are stored, and apply tenant-scoped consent and retention rules. In this manner, the PinChat system improves efficiency, organization, and comprehension in chat-based environments by providing deterministic access to pinned messages and AI-driven contextual assistance. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

In a present embodiment, PinChat enables a chat interface in which user-selected messages can be pinned and retained with their surrounding context. Pin events are captured and stored in a dedicated datastore together with metadata such as timestamps, revisit frequency, and related thread activity. This structured information is then analyzed by an AI engine to identify topics of interest, update user profiles, and generate personalized recommendations or proactive pinning suggestions. By combining contextual storage with adaptive learning, PinChat provides a more efficient, organized, and intelligent mechanism for recalling important messages within ongoing conversations.

As used herein, the term “PinChat” refers to a set of features within a conversational interface that enable a user to designate (“pin”) one or more message bubbles for persistent storage, contextual recall, and AI-assisted analysis. A pinned message is preserved together with a surrounding context window and interaction metadata, surfaced in a persistent sidebar for quick reference, and processed by an AI engine to inform user profiles, importance scoring, recommendations, and proactive assistance.

### Conventional System Limitations

Conventional chat systems provide only rudimentary bookmarking features, such as starring or flagging a message, that fail to preserve the conversational flow in which the message occurred. These mechanisms treat the saved item as an isolated artifact, leaving the user to manually reconstruct surrounding context or scroll through long threads to understand its relevance. Existing solutions also lack mechanisms for weighting the importance of a saved message based on timing, frequency of access, or downstream interactions, thereby losing signals about what content is most critical to the user. Moreover, traditional systems offer no adaptive assistance: the same static “saved messages” view is shown regardless of a user's history or behavior, and no proactive suggestions are made when recurring patterns of importance arise. As a result, users experience inefficiency when trying to retrieve information, higher cognitive load in piecing together meaning, and missed opportunities for the system to learn from repeated signals of user interest.

### Technical Improvements of the Present Disclosure

The present embodiment introduces technical improvements that directly address these limitations. A pinning service deterministically associates a selected utterance with its surrounding context window, preserving both the content and its conversational sequence in a structured datastore. Interaction metadata—such as time-to-pin relative to creation, frequency of recall, duration of sidebar display, and sub-thread activity—is recorded to generate an importance score that reflects the practical significance of the pinned item. An AI engine leverages these structured records to update a user profile, identify recurring topics, and generate personalized recommendations or proactive suggestions to pin similar content. A persistent sidebar surfaces the latest or most important pins with low-latency retrieval, reducing navigation overhead. Privacy safeguards ensure that only derived features are retained, while synchronization logic allows pins to persist seamlessly across devices. Collectively, these mechanisms improve efficiency of information retrieval, enhance comprehension through context-aware recall, and provide adaptive personalization that evolves over time.

In some embodiments, the technical improvements of the present embodiment extend directly to the pinning and contextual recall features. Unlike conventional chat systems that merely allow a user to “star” or “save” messages without regard to surrounding flow, PinChat deterministically associates a pinned utterance with its contextual window, preserves interaction metadata such as time-to-pin and revisit frequency, and adapts sidebar presentation accordingly. The AI engine leverages these structured records to update user profiles, infer topic importance, and generate personalized recommendations. By combining structured context capture with adaptive modeling, the system improves fidelity of information retrieval, reduces user navigation overhead, and enhances comprehension in chat-based environments, while maintaining privacy safeguards.

The following figure provides a high-level overview of the system architecture illustrating key modules and data flows between user devices and the server.

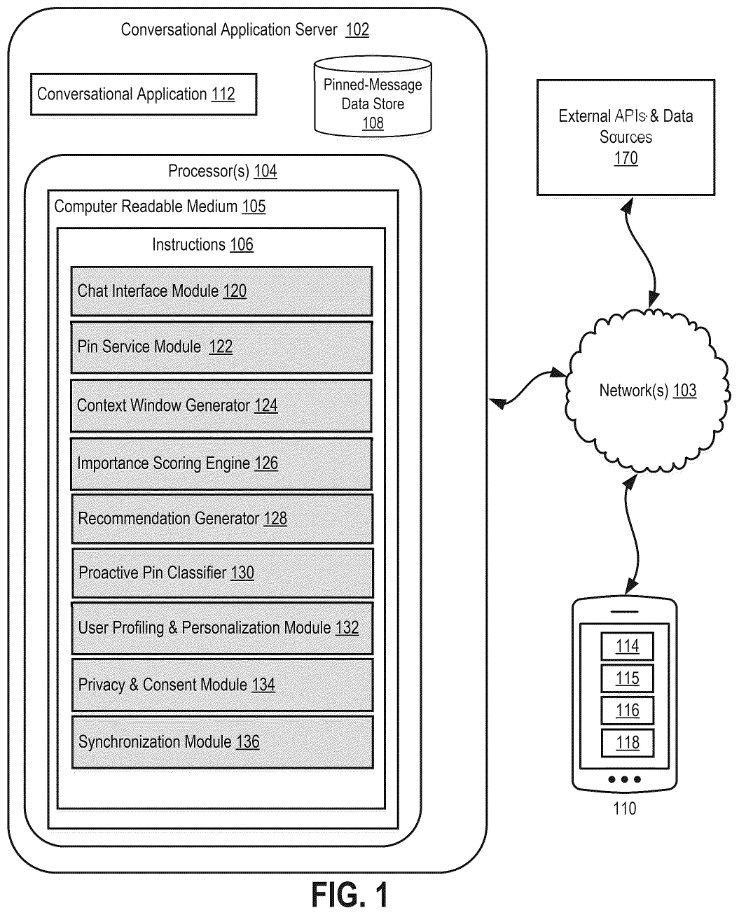

FIG. 1 is a block diagram illustrating an exemplary system architecture for context-preserving pinning and AI-assisted retrieval in a conversational user interface, according to a present embodiment. System 100 includes a conversational application server 102 coupled via network(s) 103 to one or more client devices 110 (illustrated as a user device with components 114-118). The server 102 includes processor(s) 104, a computer-readable medium 105 storing instructions 106, a pinned-message data store 108, and a conversational application 112. The instructions 106 configure functional modules comprising: chat interface module 120, pin service module 122, context window generator 124, importance scoring engine 126, recommendation generator 128, proactive pin classifier 130, user profiling and personalization module 132, privacy and consent module 134, and synchronization module 136. The system may further communicate with external APIs and data sources 170 via the network(s) 103 to retrieve embeddings, domain knowledge, or related content used in recommendations.

The client devices 110 (e.g., smartphone, tablet, or desktop) execute a user-facing interface to interact with the conversational application 112 and may include a chat interface 114, a local pin cache 115 for offline storage and later synchronization, a pinned sidebar 116 for displaying the latest or most important pins, and a recall overlay 118 for re-presenting a pinned message together with its associated context. In some embodiments, the local pin cache 115 ensures that pinning functionality remains available even in low-connectivity environments, with reconciliation handled by synchronization module 136 when network access is restored.

Hardware processor 104 may be one or more central processing units (CPUs), semiconductor-based microprocessors, and/or other hardware devices suitable for retrieval and execution of instructions stored in computer readable medium 105. Processor 104 may fetch, decode, and execute instructions 106, to control processes or operations for automatically categorizing tasks and assigning color. As an alternative or in addition to retrieving and executing instructions, hardware processor 104 may include one or more electronic circuits that include electronic components for performing the functionality of one or more instructions, such as a field programmable gate array (FPGA), application specific integrated circuit (ASIC), or other electronic circuits.

A computer readable storage medium, such as machine-readable storage medium 105 may be any electronic, magnetic, optical, or other physical storage device that contains or stores executable instructions. Thus, computer readable storage medium 105 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 105 may be a non-transitory storage medium, where the term “non-transitory” does not encompass transitory propagating signals. As described in detail below, machine-readable storage medium 105 may be encoded with executable instructions, for example, instructions 106.

The disclosed system operates within a modular, service-oriented architecture designed to support scalable, context-preserving pinning and AI-assisted retrieval in a conversational user interface. FIG. 1 provides a high-level overview, showing key functional modules and data flows between client devices and the server.

In an exemplary implementation, the system includes a conversational application server 102 configured to facilitate chat interactions while capturing pin events, preserving surrounding context, and delivering adaptive recommendations. The server 102 executes a conversational application 112 that orchestrates message flow, manages user profiles, and invokes pinning, scoring, and personalization modules in real time. The server comprises one or more processors 104 and a computer-readable medium 105 that stores instructions 106 executable by the processors. These instructions include a chat interface module 120 configured to render assistant/user utterances, collect user inputs, expose interface controls for pin/unpin actions, and maintain a sidebar display of pinned content.

In the following sections, each module is described in further detail with reference to specific functions, workflows, and interface elements.

A pin service module 122 is configured to receive pin and unpin commands initiated from a client interface. Upon a pin event, a context window generator 124 determines the appropriate surrounding messages (e.g., ±N messages or semantically related utterances) to be stored with the pinned message. An importance scoring engine 126 calculates a weighted score based on interaction metadata such as time-to-pin, dwell duration, reopen count, and sub-thread activity. A recommendation generator 128 retrieves related messages, actions, or resources that align with the pinned topic, while a proactive pin classifier 130 predicts when to suggest pinning additional content based on historical patterns. A user profiling and personalization module 132 adapts thresholds and recommendation logic to individual behavior, evolving from population priors to per-user profiles. A privacy and consent module 134 governs which metadata are retained, applies anonymization or minimization techniques, and enforces retention policies. A synchronization module 136 coordinates pin records across multiple client devices and reconciles offline activity.

User interaction with the system occurs via one or more client devices 110, which may include smartphones, tablets, or desktop clients equipped with communication software. Each client device 110 may include a display, a network interface, a chat interface 114, a local pin cache 115 for offline storage, a pinned sidebar 116, and a recall overlay 118 for viewing pinned messages together with their context window. The local pin cache 115 ensures that pinning and recall remain available during periods of low or no connectivity, with reconciliation performed by the synchronization module 136 when network access is restored. Devices connect to the conversational application server 102 over one or more networks 103 (e.g., the Internet or cellular data networks).

In some implementations, the server 102 also accesses external APIs and data sources 170 to augment recommendations (e.g., knowledge base entries, enterprise context, or task management integrations). Such integrations may provide additional content or related actions in response to pinned topics, subject to governance by the privacy and consent module 134.

In some embodiments, the system is deployed in a cloud environment with modular services exposed via secured APIs, enabling horizontal scalability, tenant isolation, and third-party integration. Local inference and caching may be performed on device to reduce latency and maintain privacy, while server-side modules manage persistence, personalization, and cross-device synchronization.

The system further includes a pinned-message data store 108, which serves as a centralized repository for contextual, interaction, and user-specific data used by the conversational application 112. In a present embodiment, the pinned-message data store 108 maintains: (i) pinned message records including content, identifiers, timestamps, and user associations; (ii) context windows comprising surrounding utterances, offsets, and semantic embeddings generated by the context window generator 124; (iii) interaction metadata captured by the importance scoring engine 126, such as time-to-pin, reopen counts, dwell duration, and sub-thread activity; (iv) personalization profiles consumed and updated by the user profiling and personalization module 132 (e.g., topic histograms, pin frequency distributions, acceptance/decline history); and (v) recommendation artifacts generated by the recommendation generator 128 (e.g., related content, suggested actions). The privacy and consent module 134 governs read/write access to the pinned-message data store 108 and enforces data minimization policies: in preferred embodiments, the system persists only derived features and importance scores, while raw conversation logs are handled under tenant-scoped retention policies. The pinned-message data store 108 may also cache selected materials obtained from external APIs and data sources 170 (e.g., knowledge-base snippets, enterprise context) for low-latency recommendation, subject to tenant and user consent. The pinned-message data store 108 may be maintained within the conversational application server 102 or distributed across a cloud infrastructure with tenant isolation, encryption at rest, and edge caches to support scalable access and real-time synchronization across devices and sessions. Cached materials are limited to minimally necessary, non-sensitive extracts with tenant scoping and a defined time-to-live.

User interaction with the system occurs via one or more client computing devices 110, which may include smartphones, tablets, or desktop clients equipped with communication software. Each client computing device 110 includes a display, a network interface, and a chat interface 114 for interacting with the conversational application 112. In some embodiments, the client computing device 110 further includes a local pin cache 115, which provides secure, client-side storage of pinned messages and related metadata during periods of low or no connectivity. Entries stored in the local pin cache 115 are reconciled with the pinned-message data store 108 via the synchronization module 136 once connectivity is restored.

In some embodiments, the system may be accessed through standard web browsers or existing messaging platforms, enabling compatibility with a wide range of client devices without requiring specialized software installation. The client computing device 110 may interact with the conversational application server 102 via a dedicated mobile application, an embedded widget, or third-party chat interfaces, depending on deployment context. When accessed via a browser or third-party platform, the system maintains core PinChat functionality—including pin/unpin actions, sidebar rendering, and recall overlays—within a sandboxed or embedded environment. This design allows pinning and contextual recall to be seamlessly integrated into existing communication workflows, minimizing user friction and ensuring broad cross-platform accessibility.

In some embodiments, the system may access external APIs and data sources 170 to augment recommendations and personalization. These third-party resources may include domain-specific knowledge bases, glossaries, documentation repositories, or enterprise systems (e.g., CRM, task management, ticketing) that provide contextually relevant content surfaced by the recommendation generator 128. Integration with external messaging platforms, such as Zoom, WhatsApp, or enterprise collaboration tools, may be facilitated via API-level connections, enabling users to benefit from PinChat's contextual recall and personalization even when operating outside of the native chat interface. Access to external APIs is governed by the privacy and consent module 134, least-privilege authentication, and data-minimization policies; in preferred embodiments, only derived features and contextual metadata necessary for recommendation are exchanged, and no raw conversation logs or sensitive user identifiers are transmitted.

The chat interface module 120 is configured to render conversational exchanges between a user and the system or between multiple participants. In a present embodiment, the chat interface module 120 generates a series of message bubbles representing utterances, maintains identifiers for each bubble, and exposes user controls for selecting, pinning, or unpinning messages. The module further manages layout for the pinned sidebar and recall overlay, ensuring that pinned messages remain visible without obstructing the active conversation or compose region. In some embodiments, the chat interface module 120 also applies visual indicators, such as pin icons, to distinguish pinned content from regular conversation flow.

The pin service module 122 is configured to process pin and unpin commands received from the chat interface module 120. When a user initiates a pin action, the pin service module 122 generates a pin event record including the message identifier, session identifier, and user identifier. This record is transmitted to the pinned-message data store 108 and is also queued in the local pin cache 115 for offline support. In some embodiments, the pin service module 122 implements an API layer that allows third-party chat clients or embedded widgets to issue pin events consistently across platforms.

The context window generator 124 is configured to identify conversational context surrounding a pinned message. In some embodiments, the context window includes a fixed number of preceding and following messages; in others, semantic similarity models are employed to identify utterances that are topically related to the pinned content. The generator associates offsets, timestamps, and authorship metadata with each context message and links this information to the pinned record in the data store 108. The context window generator 124 thereby ensures that a pinned message is preserved together with sufficient surrounding content to support later comprehension.

The importance scoring engine 126 calculates a weighted score for each pinned record based on interaction metadata. Features may include the time elapsed between message creation and pinning, the number of times the pinned content is reopened, the duration of sidebar dwell, and the number of sub-threads spawned from the pinned message. In some embodiments, the engine applies machine-learned weights to combine these features into a scalar importance score that reflects practical user value. The importance scoring engine 126 may also decay scores over time, allowing older pins to gradually yield priority to more recent interactions.

The recommendation generator 128 is configured to provide personalized content or actions related to pinned messages. Using topic analysis, semantic embeddings, and historical user behavior, the generator may surface related prior pins, articles, or enterprise resources. In some embodiments, the generator also suggests follow-up actions, such as creating a task, scheduling a meeting, or exporting a summary. The recommendation generator 128 may query external APIs and data sources 170 under tenant-specific policies and returns results filtered by the privacy and consent module 134.

The proactive pin classifier 130 predicts when to suggest pinning a message bubble without explicit user action. The classifier consumes features such as message length, attachment presence, author rank, importance scores of similar past pins, and observed user behavior. In some embodiments, a thresholded probability output is used to display a subtle in-thread suggestion (e.g., “Pin this for later?”) or to pre-highlight the pin icon. The proactive pin classifier 130 thereby reduces navigation overhead and ensures that messages with high expected future value are not overlooked.

The user profiling and personalization module 132 maintains per-user models that adapt system behavior based on observed pinning patterns. Profile features may include frequency of pinning, preferred topics, time-of-day patterns, and historical acceptance or rejection of recommendations. The module adjusts thresholds for the importance scoring engine 126 and proactive pin classifier 130, ensuring that outputs are tuned to individual preferences. In some embodiments, the personalization module 132 also supports federated or tenant-level aggregation, allowing models to benefit from group behavior while preserving individual privacy.

The privacy and consent module 134 governs access to pin records, metadata, and recommendations. The module enforces tenant isolation, applies data minimization techniques, and ensures that only derived features are stored when raw content is unnecessary. In some embodiments, users may configure consent preferences such as whether pinned content may be used to generate cross-session recommendations or whether pins expire after a retention interval. The privacy and consent module 134 further manages least-privilege access for external API calls and enforces encryption in transit and at rest.

The synchronization module 136 ensures consistency of pin records across multiple client devices and sessions. When offline, pin events are stored in the local pin cache 115 with vector clock or CRDT metadata. Upon reconnection, the synchronization module 136 reconciles differences between local and server states, resolving conflicts deterministically. In some embodiments, the module also manages cross-platform consistency so that pins initiated in a web client are reflected on a mobile application and vice versa. The synchronization module 136 thereby provides continuity of experience, allowing users to access their pinned content seamlessly across devices.

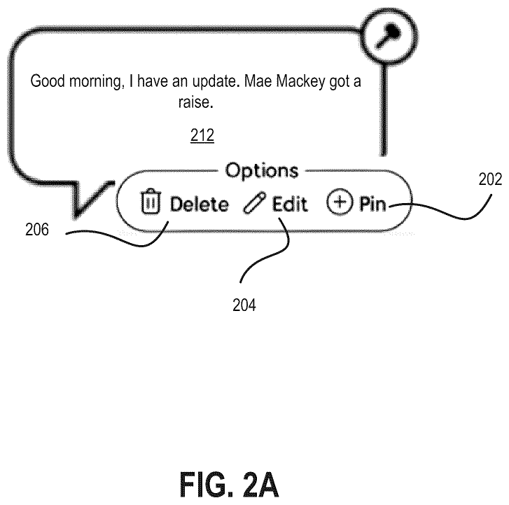

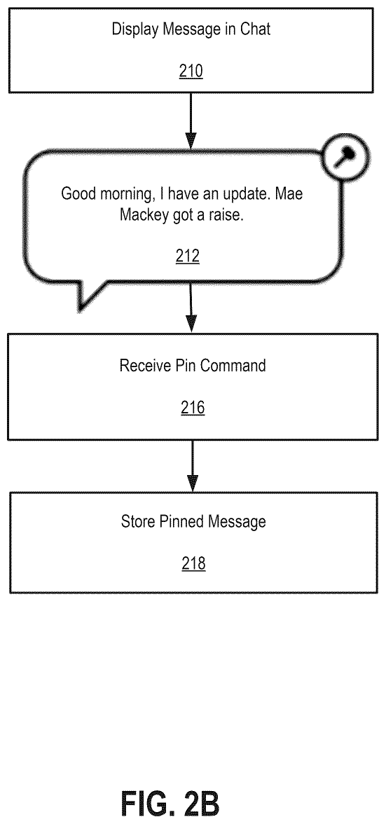

FIG. 2A is a user interface diagram illustrating a pin action workflow, according to a present embodiment. A message bubble 212 is displayed within the chat interface and is associated with an options tray 204. The options tray 204 includes actions such as delete 206, edit, and pin 202. When the user selects the pin action, the system generates a pin event associated with the message bubble 212.

FIG. 2B is a flow diagram illustrating operations for processing a pin action, according to a present embodiment. At step 210, a message is displayed in the chat interface. At step 212, the message bubble is presented with a selectable pin option. At step 216, the system receives a pin command from the user. At step 218, the system stores the pinned message together with contextual information and metadata in the pinned-message data store 108.

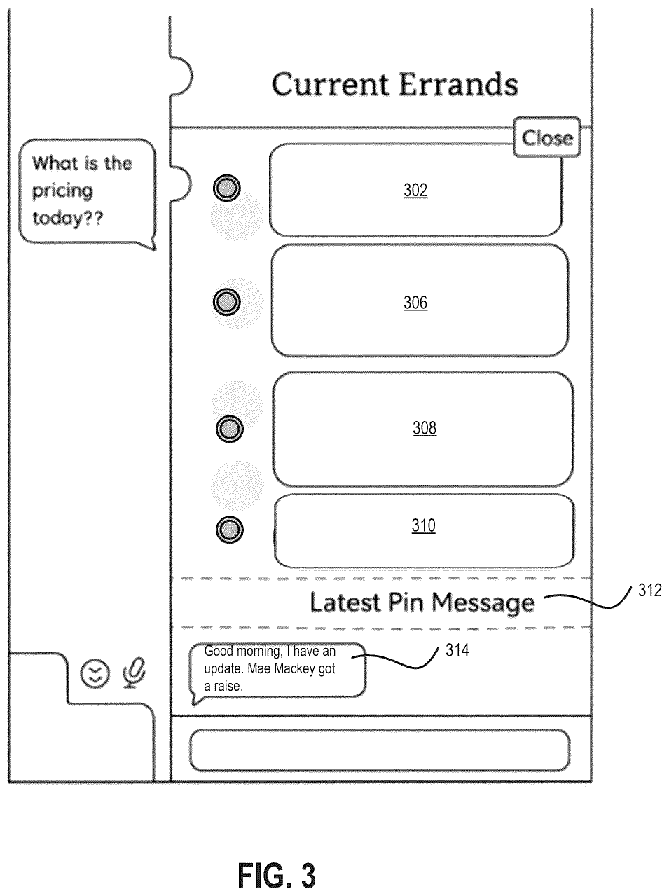

FIG. 3 is a user interface diagram illustrating display of a latest pinned message within a sidebar, according to a present embodiment. The interface includes a list of errands with message entries 302-310, each associated with a selectable bubble. A latest pin message region 312 is displayed below the list and surfaces the most recently pinned message 314 for quick access. Selecting the latest pin message 314 enables a user to view the pinned bubble together with its surrounding context window, as retrieved from the pinned-message data store 108.

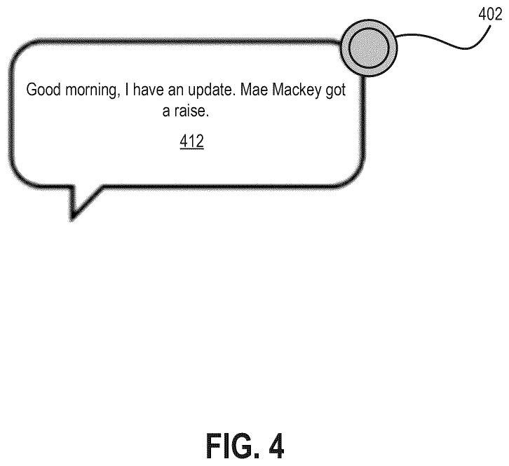

FIG. 4 is a user interface diagram illustrating a pinned message bubble, according to a present embodiment. A message bubble 412 is displayed with a pin icon indicator 402 affixed in the upper corner. The pin icon indicator 402 provides a visual cue that the message bubble has been successfully pinned and is stored in the pinned-message data store 108. In some embodiments, selecting the pin icon indicator 402 allows the user to unpin the message, thereby removing it from the latest pin message region 312 and the pinned sidebar 116.

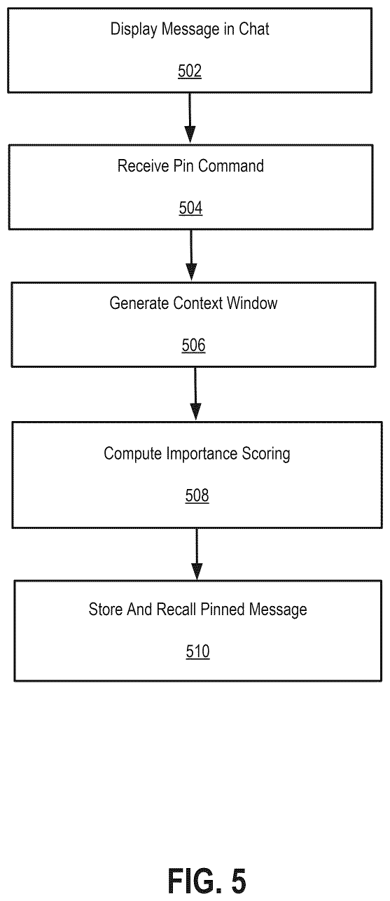

FIG. 5 is a flow diagram illustrating example operations for context-preserving pinning and AI-assisted retrieval in a conversational interface, according to a present embodiment.

The chat interface module 120 renders a plurality of message bubbles within the conversational interface 114. Each message bubble is assigned a unique message identifier and associated metadata (e.g., authorship, timestamps, thread identifier). In some embodiments, visual affordances for actions (e.g., options tray) are conditionally displayed on hover, long-press, or selection.

Responsive to user selection of a pin action, the pin service module 122 receives a pin command referencing the selected message identifier and session/user context. The pin service module 122 creates a pin event record and, when the client device 110 is offline, stages the record in the local pin cache 115 for later reconciliation.

The context window generator 124 determines conversational context to be stored with the pinned message. In one embodiment, the generator selects at least one preceding message and at least one following message in the same thread. In another embodiment, the generator computes semantic similarity to identify topically related utterances, attachments, or sub-threads, and records offsets/timestamps for each included item. The resulting context window is linked to the pin event record.

The importance scoring engine 126 computes an importance score for the pinned record based on interaction metadata. Features may include time-to-pin relative to message creation, reopen count, sidebar dwell duration, and sub-thread activity. Scores may be decayed over time and/or adapted by the user profiling & personalization module 132 to reflect user-specific preferences.

The pinned record, its context window, and the importance score are persisted in the pinned-message data store 108 and optionally cached for low-latency retrieval. The synchronization module 136 reconciles any locally cached entries from 115 with the server state. The chat interface module 120 updates the pinned sidebar 116 to surface the latest and/or highest-importance pins, and renders a recall overlay 118 that presents the pinned bubble together with at least a portion of the stored context window. Recommendations related to the pinned topic may be produced by the recommendation generator 128, and proactive suggestions to pin similar content may be issued by the proactive pin classifier 130, subject to the privacy & consent module 134.

In some embodiments, Step 506 precedes Step 504 where the client pre-computes candidate context windows; in others, Step 508 triggers only upon a threshold number of recalls or dwell events. The order of certain steps may be altered or performed in parallel without departing from the scope of the present embodiment.

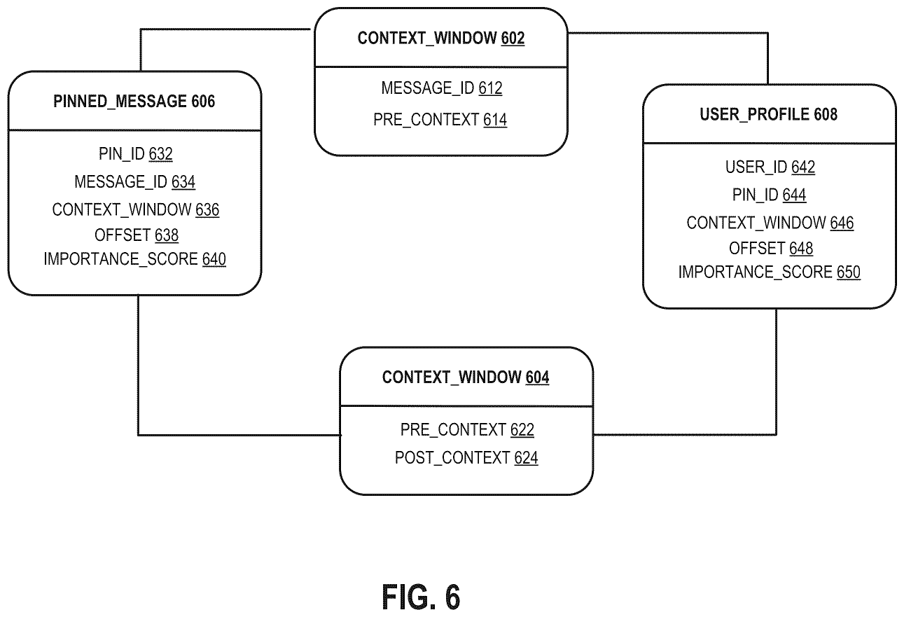

FIG. 6 is a data schema diagram illustrating exemplary structures used to persist pinned messages, context windows, and user profiles, according to a present embodiment. A pinned-message record 606 includes a pin identifier 632, a message identifier 634, one or more context-window references 636, an offset value 638, and an importance score 640. Each pinned message links to a context window 602, which stores message identifiers 612 and pre-context references 614, and may further link to additional context-window records 604 that store pre-context 622 and post-context 624 values. A user-profile record 608 is keyed by a user identifier 642 and associates pinned messages 644 with context windows 646, offset values 648, and importance scores 650. This schema enables the system to deterministically capture user pin actions, preserve surrounding context, and update per-user profiles with weighted signals reflecting historical behavior.

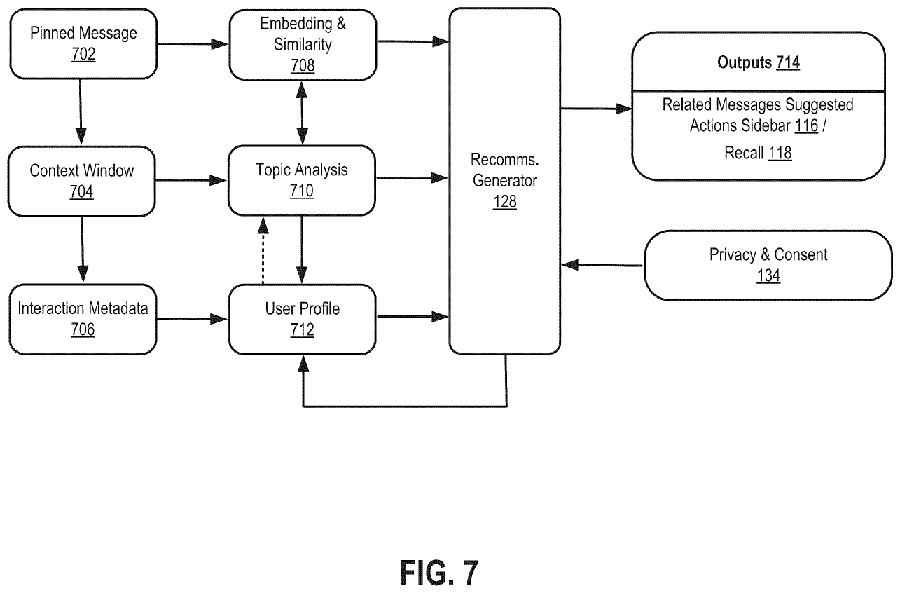

FIG. 7 is a block diagram illustrating a recommendation pipeline, according to a present embodiment. Inputs include a pinned message 702, a context window 704, and interaction metadata 706. An embedding and similarity module 708 generates vector representations and nearest-neighbor candidates. A topic analysis module 710 derives topic features from the pinned content and context window and may exchange features with the embedding and similarity module 708. A user profile 712 supplies personalization signals (e.g., topic priors, acceptance/decline history, recency decay) that condition topic analysis 710 and are consumed by the recommendation generator 128. The recommendation generator 128, subject to the privacy and consent module 134, produces outputs 714 including related messages, suggested actions, and UI placements for the pinned sidebar 116 and recall overlay 118. In some embodiments, feedback on user interactions with the outputs is persisted in the pinned-message data store 108 to update the user profile 712 and improve subsequent recommendations.

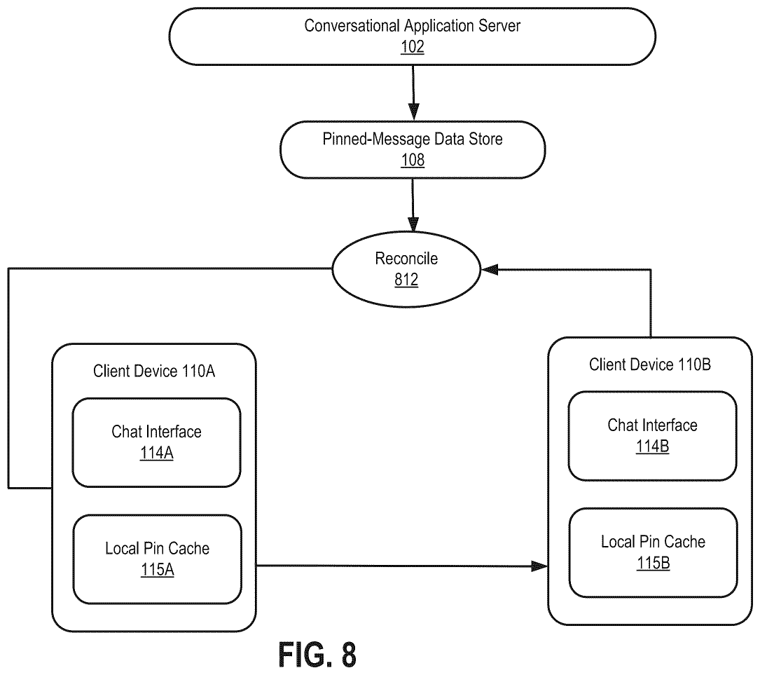

FIG. 8 is a diagram illustrating multi-device synchronization of pinned messages, according to a present embodiment. A conversational application server 102 persists pinned records in a pinned-message data store 108. Client device 110A includes a chat interface 114A and a local pin cache 115A; client device 110B includes a chat interface 114B and a local pin cache 115B. A reconciliation engine 812 receives pin/unpin events queued locally while a client is offline, reconciles such events with server state, and propagates updates to other clients. In some embodiments, the reconciliation engine 812 implements causal ordering and/or conflict-free replicated data types (CRDTs) to resolve concurrent edits. Upon network availability, reconciled updates are committed to the data store 108 and transmitted to client devices 110A-110B so that pinned items and their context windows remain consistent across devices and sessions.

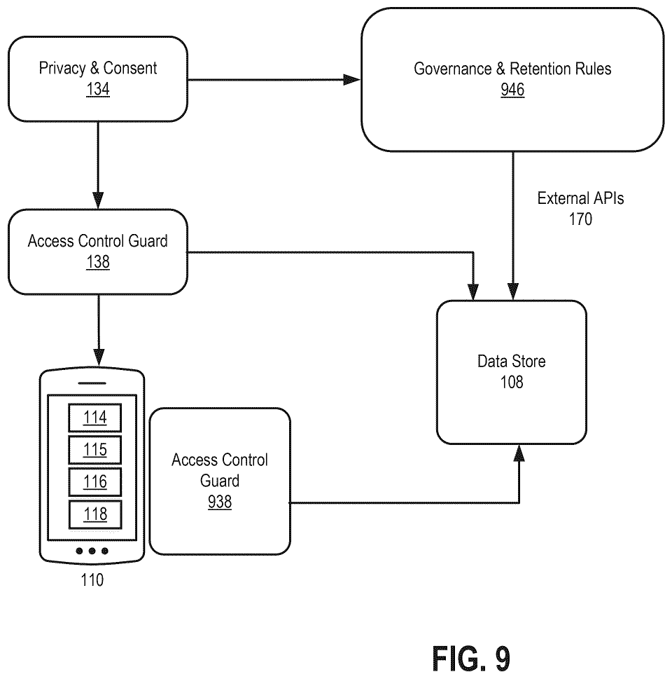

FIG. 9 is a diagram illustrating privacy, governance, and access-control flows in an alternate embodiment. A privacy & consent module 134 provides consent directives to a governance & retention rules engine 946, which applies tenant-and user-specific retention, expiration, and legal-hold policies to pinned records and derived features in the data store 108. An access control guard on the client device 110, referred to as client access control guard 938, mediates outbound synchronization by applying user-configured privacy settings and redacting or hashing selected fields from the chat interface 114, local pin cache 115, pinned sidebar 116, and recall overlay 118 prior to transmission. Server-side requests to and from the data store 108 may incorporate permissions derived from modules 134 and 946, and recommendations that rely on external APIs 170 are likewise constrained by these policies. Components 938 and 946 are optional and are not depicted in FIG. 1; other embodiments may omit one or both.

In some embodiments, a client access control guard 938 executes on device 110 to enforce local privacy controls before synchronization. The guard 938 determines which fields of a pinned record, context window, or interaction metadata are transmitted, can redact or hash sensitive fields, and can block synchronization when consent is withdrawn. The guard 938 may expose per-user settings for scope (e.g., “this device only,” “team-visible”), and integrates with the synchronization module 136 for conflict-free reconciliation.

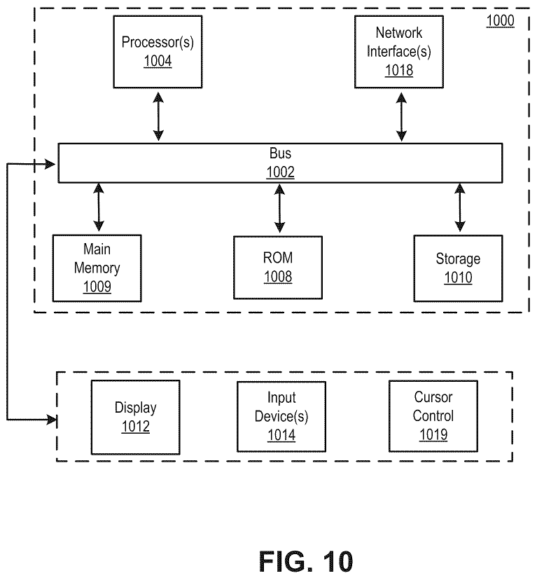

In some embodiments, governance & retention rules engine 946 defines and enforces policies for retention, expiration, and legal hold over pinned records and derived features in the data store 108. Policies may depend on tenant configuration, content classification, importance scores, or regulatory requirements. The engine 946 can (i) expire low-importance pins after a retention interval, (ii) preserve records under legal hold, and (iii) record policy outcomes for audit. In some embodiments, policy evaluations are conditioned on consent signals from module 134.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 10. Various embodiments are described in terms of this example computing module 1000. After reading this description, it will become apparent to a person skilled in the relevant art how to implement the technology using other logical circuits or architectures.

FIG. 10 illustrates an example computing module 1000, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAS, PALS, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. Various embodiments are described in terms of this example-computing module 1000. After reading this description, it will become apparent to a person skilled in the relevant art how to implement the application using other computing modules or architectures.

Referring now to FIG. 10, computing module 1000 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 1000 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 1000 might include, for example, one or more processors, controllers, control modules, or other processing devices, such as a processor 1004. Processor 1004 might be implemented using a general-purpose or special-purpose processing engine such as, for example, a microprocessor, controller, or other control logic. In the illustrated example, processor 1004 is connected to a bus 1002, although any communication medium can be used to facilitate interaction with other components of computing module 1000 or to communicate externally. The bus 1002 may also be connected to other components such as a display 1012, input devices 1014, or cursor control 1016 to help facilitate interaction and communications between the processor and/or other components of the computing module 1000.

Computing module 1000 might also include one or more memory modules, simply referred to herein as main memory 1006. For example, preferably random-access memory (RAM) or other dynamic memory might be used for storing information and instructions to be executed by processor 1004. Main memory 1006 might also be used for storing temporary variables or other intermediate information during execution of instructions to be executed by processor 1004. Computing module 1000 might likewise include a read only memory (“ROM”) 1008 or other static storage device 1010 coupled to bus 1002 for storing static information and instructions for processor 1004.

Computing module 1000 might also include one or more various forms of information storage devices 1010, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 1010 might include other similar instrumentalities for allowing computer programs or other instructions or data to be loaded into computing module 1000. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 1000.

Computing module 1000 might also include a communications interface or network interface(s) 1018. Communications or network interface(s) interface 1018 might be used to allow software and data to be transferred between computing module 1000 and external devices. Examples of communications interface or network interface(s) 1018 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 1018 might typically be carried on signals, which can be electronic, electromagnetic (which includes optical) or other signals capable of being exchanged by a given communications interface. These signals might be provided to communications interface 1018 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 1006, ROM 1008, and storage unit interface 1010. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1000 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method for context-preserving pinning and retrieval in a conversational user interface, comprising:
(a) rendering a chat interface comprising a plurality of message bubbles;
(b) receiving, via a user input to a first message bubble, a pin command;
(c) responsive to the pin command, generating a context window comprising at least one message preceding the first message bubble and at least one message following the first message bubble;
(d) persisting, in a pinned-message datastore, a pinned record comprising: an identifier of the first message bubble, the context window, and interaction metadata including a time elapsed between creation of the first message bubble and the pin command;
(e) updating a user profile using features derived from the pinned record;
(f) rendering, in a persistent sidebar, a latest pinned entry referencing the pinned record; and
(g) in response to a recall selection of the latest pinned entry, restoring a view that concurrently displays the first message bubble and at least a portion of the context window;
wherein operations (d)-(g) reduce a number of user navigation steps relative to scrolling or keyword search.

2. The method of claim 1, wherein the interaction metadata further comprises a reopen count, a dwell duration, and a sub-thread count, and an importance score is computed therefrom.

3. The method of claim 1, further comprising generating a recommendation based on the user profile, the recommendation including at least one of: a related message, a suggested reply, or a suggested action.

4. The method of claim 1, further comprising outputting a proactive suggestion to pin a second message bubble based on similarity between the second message bubble and historically pinned content.

5. The method of claim 1, wherein persisting the pinned record includes storing semantic embeddings for messages in the context window.

6. The method of claim 1, wherein the persistent sidebar displays the latest pinned entry without obscuring a compose region of the chat interface.

7. The method of claim 1, further comprising enforcing an access control policy that scopes availability of the pinned record to at least one of: a single user, a user group, or a channel.

8. The method of claim 1, wherein restoring the view comprises overlaying the context window while retaining a current scroll position of the chat interface.

9. The method of claim 1, further comprising synchronizing the pinned record across multiple client devices using conflict-free replicated data structures.

10. The method of claim 1, wherein generating the context window includes selecting a dynamic number of surrounding messages based on a topic boundary detected by an AI model.

11. A computer-implemented system for context-preserving pinning and retrieval in a conversational interface, comprising:
one or more processors; and
a non-transitory computer-readable medium storing instructions that, when executed by the one or more processors, cause the system to implement:
a chat interface module configured to render, on a client device display, a chat interface that presents a sequence of utterances;
a gaze acquisition engine interface configured to receive, during a session, a time series of gaze samples;
(a) render a chat interface comprising a plurality of message bubbles;
(b) receive, via a user input to a first message bubble, a pin command;
(c) responsive to the pin command, generate a context window comprising at least one message preceding the first message bubble and at least one message following the first message bubble;
(d) persist, in a pinned-message datastore, a pinned record comprising: an identifier of the first message bubble, the context window, and interaction metadata including a time elapsed between creation of the first message bubble and the pin command;
(e) update a user profile using features derived from the pinned record;
(f) render, in a persistent sidebar, a latest pinned entry referencing the pinned record; and
(g) in response to a recall selection of the latest pinned entry, restore a view that concurrently displays the first message bubble and at least a portion of the context window;
wherein operations (d)-(g) reduce a number of user navigation steps relative to scrolling or keyword search.

12. The system of claim 11, wherein the interaction metadata further comprises a reopen count, a dwell duration, and a sub-thread count, and an importance score is computed therefrom.

13. The system of claim 11, wherein the machine-readable instructions further cause the system to generate a recommendation based on the user profile, the recommendation including at least one of: a related message, a suggested reply, or a suggested action.

14. The system of claim 11, wherein the machine-readable instructions further cause the system to output a proactive suggestion to pin a second message bubble based on similarity between the second message bubble and historically pinned content.

15. The system of claim 11, wherein persisting the pinned record includes storing semantic embeddings for messages in the context window.

16. The system of claim 11, wherein the persistent sidebar displays the latest pinned entry without obscuring a compose region of the chat interface.

17. The system of claim 11, wherein the machine-readable instructions further cause the system to enforce an access control policy that scopes availability of the pinned record to at least one of: a single user, a user group, or a channel.

18. The system of claim 11, wherein restoring the view comprises overlaying the context window while retaining a current scroll position of the chat interface.

19. The system of claim 11, wherein the machine-readable instructions further cause the system to synchronize the pinned record across multiple client devices using conflict-free replicated data structures.

20. The system of claim 11, wherein generating the context window includes selecting a dynamic number of surrounding messages based on a topic boundary detected by an AI model.
